(19) United States
(12) Patent Application Publication
(10) Pub. No.: US 2015/0285463 A1
(43) Pub. Date: Oct. 8, 2015

(54) LIGHTING DEVICE FOR INDIRECT ILLUMINATION HAVING PRISM ELEMENTS

(71) Applicant: KONINKLIJKE PHILIPS N.V., EINDHOVEN (NL)

(72) Inventor: Hendrikus Hubertus Petrus Gommans, Eindhoven (NL)

(21) Appl. No.: 14/437,036

(22) PCT Filed: Oct. 15, 2013
(86) PCT No.: PCT/IB2013/059363

§ 371 Date: Apr. 20, 2015

Related U.S. Application Data
(60) Provisional application No. 61/715,938, filed on Oct. 19, 2012.

(51) Int. Cl. F21V 13/04; F21V 5/02; F21V 7/00

(52) U.S. Cl. CPC F21V 13/04; F21V 7/0008; F21V 5/02

(57) ABSTRACT

According to an aspect of the invention, a lighting device is provided. The lighting device comprises a light source, and an optical structure. The optical structure has an exit surface for outputting light and a reflective surface for reflecting light from the light source towards the exit surface. Further, the optical structure comprises a plurality of prism elements arranged at the exit surface for redirecting light from the reflective surface by means of total internal reflection and/or refraction. With prism elements arranged on the exit surface, a portion of the light reflected by the reflective surface is redirected, thereby widening the light intensity distribution of the lighting device and increasing the area illuminated by the lighting device.

### FIELD OF THE INVENTION

The present invention generally relates to the field of lighting devices for indirect illumination.

### BACKGROUND OF THE INVENTION

Indirect illumination is normally used as general illumination in offices and the like spaces. Indirect illumination is achieved by illuminating a secondary surface (such as a ceiling or wall), which reflects light from towards an object (or space) to be illuminated. In conventional lighting systems, fluorescent lamp tubes in reflecting housings are used to create indirect illumination. However, such fluorescent lamp tubes are currently being replaced by more energy efficient solid state based alternatives, such as light emitting diode (LED) based lighting devices. WO-2011/051925 shows a LED-based lighting device for indirect illumination. The lighting device comprises LEDs and a diffuse reflector for reflecting the light from the LEDs towards a ceiling.

### SUMMARY OF THE INVENTION

It is an object of at least some of the embodiment of the present invention to provide a lighting device able to illuminate a region which is larger than that obtained by prior art lighting devices. It is also an object of the present invention to provide a lighting device able to more uniformly illuminate a secondary surface.

According to an aspect of the invention, a lighting device is provided. The lighting device comprises a light source, and an optical structure. The optical structure has an exit surface for outputting light and a concave reflective surface for reflecting light from the light source towards the exit surface. Further, the optical structure comprises a plurality of prism elements arranged at the exit surface for redirecting light from the reflective surface by means of total internal reflection and/or refraction.

The inventors have realized that the size of an area of a secondary surface (e.g. a ceiling or wall) illuminated by a lighting device determines the number of lighting devices for indirectly illuminating a specific region. In general, it would be desirable to provide a lighting device able to illuminate a larger area of a secondary surface so as to reduce the total number of lighting devices required to indirectly illuminate a specific region. The present invention uses the concept of shaping the light intensity distribution of the lighting device in order to increase the achievable illumination area (or illumination coverage) of the lighting device. With prism elements arranged at (or on) the exit surface, a portion of the light reflected by the reflective surface is redirected into directions other than the light outputted through the exit surface without passing the prism elements (e.g. more towards the secondary surface), thereby widening the light intensity distribution of the lighting device and increasing the area illuminated by the lighting device. The larger illumination area is advantageous in that it reduces the number of lighting devices required to illuminate a specific area.

Normally, light emitting diodes (LEDs), which output light of a specific wavelength, are used in combination with phosphor (or any other wavelength converting material) for providing white light. An LED usually comprises a blue emitting active region positioned at the centre of the LED package and a yellow emitting phosphor surrounding the active region and filling up the remainder of the package. The travelling distance for the light emitted by the active region through the phosphor determines the amount of blue light being absorbed (and thus converted) by the phosphor. In directions perpendicular to the emitting surface of the active region, the travel distance shorter (whereby the light output is more towards blue in these directions) compared to directions forming a wider angle to the emitting surface of the active region (in which directions the light output is more towards yellow). Hence, a color over (emission) angle is obtained and a color gradient may be visible across the light distribution of the lighting device. In particular, the color which the phosphor has converted the light into (yellow), may be visible at the edges of the light distribution. Hence, the color of the light reflected by the reflective surface varies over the exit surface of the optical structure. The prism elements facilitate control of the light output. For example, a portion of the light reflected by the reflective surface having a particular color may be redirected by the prism elements such that that portion of light is projected onto another portion of light outputted by the lighting device having another color, thereby mixing the light and making the color distribution more uniform.

According to an embodiment of the present invention, the lighting device may be adapted for illuminating a secondary surface, thereby providing indirect illumination via reflection from the illuminated secondary surface. Hence, the lighting device may be mounted in proximity to the secondary surface such that the main light output is directed towards the secondary surface. Indirect illumination may be used for illuminating a space (such as an office) and for reducing glare from the light source.

According to an embodiment, the exit surface, the reflective surface and the light source may be arranged such that a major portion of the light outputted through the exit surface without passing the prism elements is outputted towards the secondary surface in a range of directions. That range of directions may define an angle interval relative to a normal to the secondary surface, the angle interval being within the range of 45 degrees to 90 degrees, preferably within the range of 55 degrees to 85 degrees, and even more preferably within the range of 70 degrees to 85 degrees. Hence, a major portion of the light (or light intensity) outputted through the exit surface without passing the prism elements may reach rather far away from the lighting device when the lighting device is installed and in use, thereby increasing the possible illumination area of the lighting device. Preferably, the light intensity increases with an increased angle relative to a normal to the secondary surface for making the illumination of the secondary surface more uniform in terms of light intensity. A higher angle of the light output relative to the secondary surface means that the light reaches further away from the lighting device at the secondary surface for a specific mounting distance from the secondary surface.

It will be appreciated that the secondary surface is not, as such, a part of the lighting device, but will cooperate with the lighting device when the lighting device is installed (and in use) in order to create indirect illumination. Further, it will be appreciated that, in the present specification, the light directions and the location of the lighting device defined relative to the secondary surface are applicable when the lighting device is installed (and in use).

According to an embodiment, the prism elements, the exit surface, the reflective surface and the light source may be arranged such that a major portion of the light redirected by the prism elements is outputted towards the secondary surface in a range of directions. That range of directions may define an angle interval relative to a normal to the secondary surface, the angle interval being within the range of 0 degrees to 80 degrees, and preferably within the range of 0 degrees to 75 degrees. Hence, a major portion of the light (or light intensity) outputted through the prism elements may reach rather close to the lighting device when the lighting device is installed and in use. The light distribution obtained by the prism elements may hence complement the light distribution obtained by the light exiting the exit surface without passing the prism elements, thereby increasing the illumination area of the lighting device.

For example, the orientation and beam shaping characteristics of the components in the lighting device (such as of the prism elements and/or the exit surface and/or the reflective surface and/or the light source) relative to each other may be selected (or configured) for obtaining the angular distributions described above.

It will be appreciated that the range of directions of the light outputted by the prism elements and the range of directions of the light outputted without passing the prism elements may, or may not, at least partially overlap. Preferably, these two ranges of directions are adapted so as to provide an overall more uniform light intensity distribution of the lighting device.

According to an embodiment, the optical structure may comprise a solid light transmissive body, which is advantageous in that a single component may be used for providing the optical structure including the exit surface and the reflective surface, which facilitates manufacturing, as well as recycling of the lighting device.

In an embodiment, the lighting device may further comprise means for collimating light from the light source before reflection by the reflective surface. The collimating means may include any beam shaping means, such as a lens and/or a reflector. Alternatively, or as complement, the solid light transmissive body of the optical structure may have a refractive index being configured such that light from the light source is refracted into a more narrow beam when entering the body so as to provide the means for collimating light. Hence, the refractive index of the body of the optical structure may be selected such that the light emitted by the light source is collimated when passing the optical structure interface. Preferably, the lighting device may be arranged such that the light from the light source propagates from a medium (e.g. air) with a lower refractive index compared to the refractive index of the body, whereby the light is collimated when propagating into the body.

LEDs usually have a Lambertian light emission pattern. By collimating the light from the light source, it is concentrated onto the reflective surface, which may then further shape the light beam. The degree of collimation is a measure for the angular beam spread obtained by collimating means and is normally expressed as a full width half max (FWHM). Preferably, the full width half maximum (FWHM) of the degree of collimation of the collimated light before it is reflected by the reflective surface is comprised within the interval of 60 degrees to 30 degrees and preferably within the interval of 50 degrees to 40 degrees. A major part of the light from a rather point-like light source may then be projected onto the reflective surface.

According to an embodiment, the reflective surface may be curved so as to collimate light from the light source. The collimation provided by the reflective surface improves the possibility to more accurately define the light output from the lighting device. Further, the reflective surface may then both redirect and concentrate light from the light source into a number of desired directions (e.g. according to the angular distribution described above). Preferably, the FWHM of the degree of collimation of the light collimated by the reflective surface may be less than 15 degrees and preferably less than 10 degrees. Hence, the light beam collimated by the reflective surface may be (at least) almost parallel. A more parallel beam further facilitates determining placement of the prism elements for obtaining a specific light output from the lighting device.

In an embodiment, the reflective surface of the optical structure may be adapted to redirect light from the light source by means of total internal reflection (TIR). For example, the air/optical structure interface may provide the reflective surface. The light source and reflective surface may preferably be oriented relative to each other such that the angle of incident of the incident light relative to the reflective surface is sufficiently high for obtaining TIR at the reflective surface.

According to an embodiment of the present invention, the exit surface may extend in a plane transverse (such as substantially perpendicular) to the average (or main) direction of the light reflected by the reflective surface, whereby the refraction of light at the exit surface/air interface is reduced. Hence, the beam shaped by the reflective surface is outputted from the exit surface (at areas absent of prism elements) without much further influence on the light direction, thereby facilitating shaping of the light output of the lighting device.

The shape and orientation of the concave reflective surface (relative to the light source) may preferably be configured so as to collimate and redirect light from the light source towards the secondary surface, preferably such that a major portion of the light outputted through the exit surface without passing the prism elements is outputted towards the secondary surface in a range of directions forming an angle interval relative to a normal to the secondary surface comprised within the range of 45 degrees to 90 degrees (as previously described). Advantageously, the curvature of the reflective surface may be adapted such that the intensity, I, of the light reflected by the reflective surface increases with the angle, θ, of the direction of the reflected light relative to the normal to the secondary surface according to the equation:

I(θ)=cos⁻²(θ)±D (Equation 1)

wherein D is a deviation ranging from 0 to 20% of the maximum intensity, Iₘₐₓ, of the light reflected by the reflective surface. The present configuration of the reflective surface is advantageous in that the uniformity of the illumination of the secondary surface is enhanced, as the light intensity across the range of emission directions is adapted to the impinging angle of the light outputted from the exit surface (without passing the prism elements) to the secondary surface. Preferably, the deviation may range from 0 to 15%, such as 0 to 10% or 0 to 5%, of the maximum intensity, Iₘₐₓ, of the light reflected by the reflective surface.

It is noted that the invention relates to all possible combinations of features recited in the claims. Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiments of the invention.

FIG. 1 shows a desired normalized light intensity distribution for a lighting device providing indirect illumination.

FIG. 2 shows a lighting device according to an embodiment of the present invention.

FIG. 3 shows an enlarged view of an exit surface of the lighting device shown in FIG. 2.

FIGS. 4 to 6 show prism elements according to embodiments of the present invention.

All the figures are schematic, not necessarily to scale, and generally only show parts which are necessary in order to elucidate the invention, wherein other parts may be omitted or merely suggested.

### DETAILED DESCRIPTION OF THE EMBODIMENTS

The size of the area illuminated by a lighting device for indirect illumination (herein after referred to as the illumination area) determines how many lighting devices are required to illuminate a certain region. A larger illumination area requires fewer lighting devices, which may be more sparsely arranged. Further, in office lighting, it is often desirable to mount the lighting device(s) relatively close to (such as 20-60 cm from) the secondary surface in order to save space. It is also desirable to provide a relatively uniform illumination of the secondary surface in order to provide a relatively uniform indirect illumination of the space.

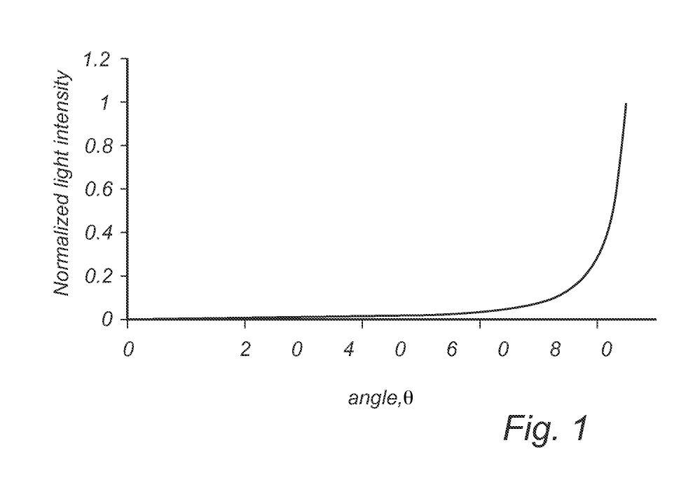

As an illustrative example, if a lighting device is mounted 40 cm from the secondary surface and the illumination area shall extend 4 m from the lighting device, the light impinging at the secondary surface between approximately 2 m to 4 m from the lighting device shall be emitted in directions having angles between approximately 79 degrees and 84 degrees relative to the normal to the secondary surface. In other words, the beam direction range of 79 degrees to 84 degrees covers about half of the illumination area. Thus, preferably approximately half the luminous flux may be emitted within this direction range for providing more uniform illumination. To further illustrate this, a desired angular dependent light intensity distribution of a lighting device for indirect illumination is shown in FIG. 1. The desired normalized light intensity is plotted dependent on the angle θ of the direction of the emitted light relative to the normal to the secondary surface. The inventors have realized that it is desirable that the light intensity increases for an increase of the angle θ in accordance with a cos⁻² θ function, as shown in FIG. 1, for obtaining a more uniformly lit illumination area.

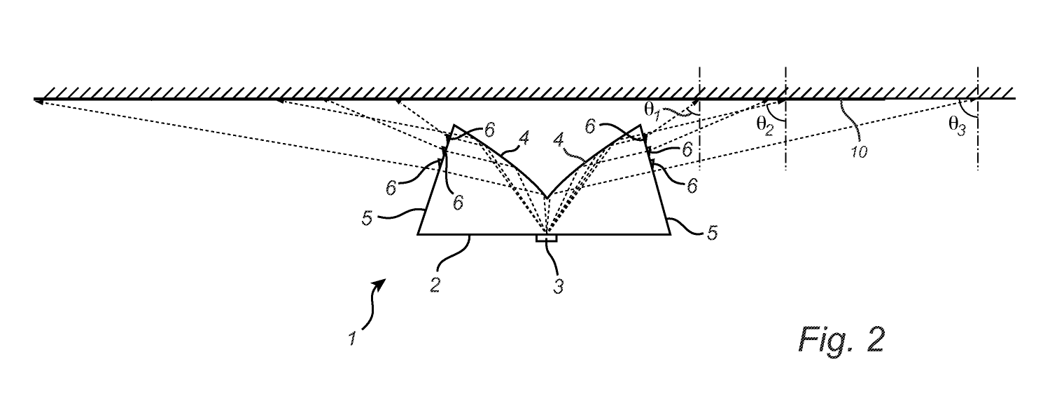

A lighting device according to an embodiment of the present invention is designed to provide a light distribution resembling the distribution shown in FIG. 1. Such a lighting device will be described with reference to FIGS. 2 to 6.

FIG. 2 shows a lighting device 1 being adapted to illuminate a secondary surface 10 for providing reflection from the secondary surface 10, thereby providing indirect illumination of a space or object, such as an office. The secondary surface 10 may e.g. be a ceiling or wall of the space to be indirectly illuminated. The lighting device 1 may be adapted to be mounted to the secondary surface 10, e.g. as a pendant lamp. The lighting device 1 may therefore be equipped with hanging means or other attachment system (not shown) to hang from the secondary surface 10. The lighting device 1 comprises at least one light source 3 and an optical structure 2 having an exit surface 5 for outputting light and a reflective surface 4 for reflecting light from the light source 3 towards the exit surface 5. The light source 3 may be a solid state based light source, such as a light emitting diode (LED). The light source may be arranged in abutment to, or at least in proximity to the optical structure 2.

The optical structure 2 (or optical body) may preferably be a solid body made of a light transmissive material, such as transparent plastic or glass. Preferably, the refractive index of the optical structure 2 may be adapted so as to provide a refractive index transition (or junction) at the light source/optical structure interface in case the light source 3 is arranged in abutment to the optical structure 2, or at the air/optical structure interface in case an air gap is present between the light source 3 and the optical structure 2. As the light from the light source 3 enters the optical structure 2, it is refracted into a more narrow beam. Hence, the refractive index transition provides means for collimating the light from the light source 3. Alternatively, or as a complement, other means for collimating the light from the light source 3 may be used in the lighting device 1, such as a parabolic reflector or a lens (not shown). Preferably, the full width half maximum (FWHM) of the degree of collimation of the collimated light may be comprised within the interval of 60 degrees to 30 degrees and preferably within the interval of 50 degrees to 40 degrees, such as around 42 degrees in order to project a major part of the light from the light source 3 onto the reflective surface 4. With the present embodiment, the light source 3 and the collimating means are arranged such that the average direction of the light collimated by the collimating means is directed transverse to the secondary surface 10.

Further, the refractive index of the optical structure 2 may be adapted so as to obtain total internal reflection (TIR) at the air/optical structure interface at the reflective surface. Hence, light from the light source 3 is reflected at the reflective surface 4 by TIR.

Alternatively, or as a complement, the reflective surface may comprise a reflective film or the like for reflecting light from the light source 3. Preferably, the reflective surface 4 may be a specular reflective surface.

The reflective surface 4 may be curved (e.g. concave) and preferably face away from the secondary surface 10 so as to provide a particular light intensity distribution of the reflected light. The degree of collimation provided by the means for collimating light (before it is reflected by the reflective surface 4) in combination with the curvature of the reflective surface 4 may preferably be chosen such that the intensity of the reflected light increases for an increase of the angle of the direction of the reflected light relative to the reflective surface 4. Further, the reflection coefficient of the reflective surface 4 may be adapted (e.g. by using different deposition techniques) to obtain the desired light intensity distribution of the reflected light. Thus, the intensity of light reflected by the reflector 4 increases with the angle of the direction of the light relative to the normal to the secondary surface 10, whereby a higher light intensity is achieved for light emitted in directions with higher angle (such as angle θ₁ illustrated in FIG. 2) relative to the normal to the secondary surface 10 compared to light emitted in directions with lower angle (such as angle θ₂ illustrated in FIG. 2) relative to the normal to the secondary surface 10.

Preferably, the curvature of the reflective surface 4 may be adapted such that the intensity of the reflected light increases with an angular dependency that is approximately equal to 1/cos², thereby further enhancing the uniformity of the light distribution of the lighting device 1. In other words, the light intensity I may vary as a function of the angle θ of the direction of the reflected light relative to the normal to the secondary surface 10 according to Equation 1.

I(θ)=cos⁻²(θ)±D (Equation 1)

D is a deviation ranging from 0 to 20%, such as from 0 to 10%, of the maximum light intensity Iₘₐₓ of the light reflected by the reflective surface 4.

Further, the curved reflective surface 4 may serve to collimate light from the light source 3. Hence, the light from the light source 3 is collimated a second time by the reflective surface 4. Preferably, the FWHM of the degree of collimation of the light collimated by the reflective surface 4 may be less than 15 degrees and preferably less than 10 degrees. Hence, the light beam collimated by the reflective surface 4 may be (at least) almost parallel.

The exit surface 5 may preferably extend in a plane transverse (preferably substantially perpendicular) to the main (or average) direction of the light reflected by the reflective surface 4 in order to reduce refraction of light outputted through the exit surface 5. Hence, in the present embodiment, the exit surface 5 is slightly tilted compared to the normal to the secondary surface.

At the exit surface 5, prism elements 6 are arranged for redirecting a portion of the light reflected by the reflective surface 4. The prism elements 6 are arranged to complement the light distribution obtained by the light reflected by the reflective surface 4 without passing the prism elements 6, by redirecting light into directions having a lower angle relative to the normal to the secondary surface 10 (e.g. angle θ₃ illustrated in FIG. 2) than the light outputted without passing the prism elements 6. Hence, light redirected by the prism elements 6 will illuminate an area of the secondary surface 10 closer to the lighting device 1 than the area illuminated by light outputted from the exit surface 5 without passing the prism elements 6. Preferably, a major portion of the light redirected by the prism elements 6 is outputted in a range of directions towards the secondary surface 10, which range of directions may define an angle interval relative to a normal to the secondary surface, the angle interval being comprised within the range of 0 degrees to 80 degrees, and preferably within the range of 0 degrees to 75 degrees. Further, a major portion of the light outputted through the exit surface 5 without passing the prism elements 6 may preferably be outputted in a range of directions towards the secondary surface 10, which range of directions may define an angle interval relative to the normal to the secondary surface 10, the angle interval being comprised within the range of 45 degrees to 90 degrees, preferably within the range of 55 degrees to 85 degrees, and even more preferably within the range of 70 degrees to 85 degrees.

Hence, the beam shaping characteristic (such as the curvature, reflection coefficient and orientation) of the reflective surface 4 and the beam shaping characteristics (such as the triangular shape and orientation) of the prism elements 6 are selected so as to provide the desired intensity distribution.

According to an example, the lighting device 1 may be suspended approximately 40 cm from the secondary surface 10 and the illumination area may reach up to 2 m from the lighting device 1. The light outputted from the exit surface 5 without passing the prism elements 6 may then cover one fourth of the illumination area reaching 1.5 m to 2 m away from the lighting device 1, which corresponds to the angular range of 75 degrees to 79 degrees of the outputted light relative to the secondary surface 10. The remaining three forth of the illumination area in terms of angular range is covered by light redirected by the prism elements 6.

It will be appreciated that the illustrations in the drawings may not be according to scale, in particular not the size of the illumination area relative to the size of the lighting device, which have been adjusted in the drawings in order to clearly illustrate both the lighting device and its illumination area in the same figure.

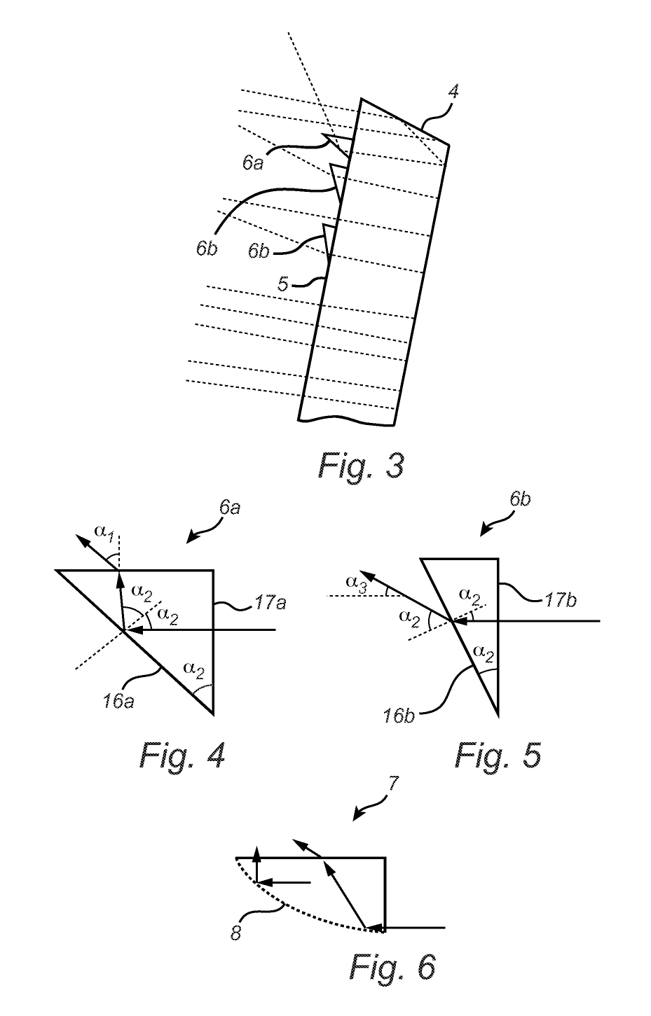

Turning now to FIGS. 3 to 6, embodiments of the prism elements will be described in more detail.

FIG. 3 is an enlarged view of the exit surface 5 of the optical structure 4 illustrating the optical path of light outputted by the lighting device 1. The light outputted through the prism elements 6a, 6b is refracted and/or reflected towards the secondary surface. The prism elements 6a, 6b has a triangular shape and comprise a base 17a, 17b making optical contact with the exit surface 5, and an inclined surface 16a, 16b being inclined relative to the base 17a, 17b. The triangular shape may optionally have one right angle.

In the present embodiment, a prism element 6a is adapted to redirect light by TIR (such prism elements may also be referred to as TIR prism elements), as shown in FIG. 4. The angle α₂ of the inclined surface 16a relative to a base 17a of the prism element 6a is adapted such that the angle of incidence of the light relative to the inclined surface 16a is sufficiently high to obtain TIR at the inclined surface 16a. In the present example, wherein the prism element 6a is oriented such that the base 17a of the prism element 6a is (at least almost) perpendicular to the light beam obtained from the reflective surface (i.e. the base 17a of the prism element 6a is arranged parallel to the exit surface 6), the angle of incidence on the inclined surface 16a is the same as the angle α₂ of the inclined surface 16a relative to the base 17a.

Further, one or more prism elements 6b may be adapted to redirect light by refraction (such prism elements may also be referred to as refraction prism elements) as shown in FIG. 9. The angle α₂ of the inclined surface 16b relative to the base 17b of the prism element 6b is adapted such that the angle of incidence of the light relative to the inclined surface 16b is sufficiently low to obtain refraction (and not TIR) at the inclined surface 16a. In the present example, wherein the base 17b of the prism element 6b is (at least almost) perpendicular to the light reflected by the reflective surface, the angle of incidence is the same as the angle α₂ of an inclined surface 16b relative to a base 17b. The desired direction of the light output from the refraction prism element 6b is dependent on the refractive index of the refraction prism element 6b and may be calculated using Snell's law. A preferable angle α₂ of the inclined surface 16b relative to the incident light can be calculated from α₃=α₁−α₂, wherein α₁ is the angle of the refracted light relative to a normal to the inclined surface 16b, α₃ is the desired angle of the refracted light relative to the incident light, and the relation between α₁ and α₂ is given by Snell's law. By increasing α₂, the refracted light forms a lower angle relative to the normal to the secondary surface (and the angle α₃ of the refracted light relative to the incident light increases). However, the angle of the redirected light relative to the secondary surface may not be less than 30 degrees, as a higher α₂ may result in the incident light being instead reflected at the inclined surface by TIR (as in the TIR prism element 6a). Hence, the refraction prism elements 6b may preferably cover the angular range of the light output approximately from 40 degrees to 75 degrees and the TIR prism elements 6a may cover the angular range of the light output approximately from 0 degrees to 40 degrees relative to the secondary surface.

According to an embodiment, the prism element 7 may have a curved (such as concave) inclined surface 8, at which TIR and/or refraction takes place, as shown in FIG. 6. The concave surface 8 increases the range of directions into which incident light is redirected by a single prism element 7. The present embodiment is advantageous in that the light distribution of the lighting device is more uniform.

Turning again to FIG. 2, a further embodiment of the present invention will be described. Phosphor (or any other type of wavelength converting material) may be arranged to convert at least a portion of the light emitted by the light source 3 into a different wavelength in order to obtain a particular color of the light output. For example, the LED die may be embedded in phosphor and/or a screen comprising phosphor may be arranged at the light source 3. However, using phosphor may result in a color gradient of the light projected onto the reflective surface 4 and subsequently onto the exit surface. Using for instance a yellow phosphor and a blue light source 3, light of lower correlated color temperature (CCT) may be projected onto the edges of the reflective surface 7. The rays with different CCT are oriented in substantially the same direction since they are collimated by the reflective surface, and are separated in position at the exit surface 5. In other words, the CCT varies over the exit surface 5 (i.e. with the position at the exit surface 5). The position of the prism elements 6 may preferably be selected so as to mix the light output. For example, one or more prism elements 6 may be located at a position of the exit surface 5 where light of higher CCT is projected, in order to redirect that light onto a region of the secondary surface where light of lower CCT is projected, thereby making the light output more uniform in terms of color.

According to an embodiment of the present invention, the lighting device 1 may preferably comprise two mirrored halves, i.e. two similarly configured halves for emitting light in two opposite main directions, as illustrated in FIG. 2. Hence, the lighting device may comprise two reflective surfaces 4, two exit surfaces 5, each having a set of prism elements 6 mounted thereto. Preferably, a single solid light transmissive body may form both the mirrored halves. Hence, the mirrored halves may intersect laterally at the centre of the body. Further, the same light source 3 may be utilized for illuminating both reflective surfaces 4 and may be arranged laterally at the centre of the body.

The lighting device 1 may be a linear lighting device, comprising a row of light sources 3 and an elongated optical structure 4. In that case, the prism elements 6 may extend in a longitudinal direction along the elongated optical structure 4 and have prism shaped cross-sections.

While embodiments of the invention have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A lighting device for illuminating a secondary surface, thereby providing indirect illumination via reflections from the illuminated secondary surface, the lighting device comprising:
a light source, and
an optical structure having an exit surface for outputting light and a concave reflective surface for reflecting light from the light source towards the exit surface,
wherein the optical structure comprises a plurality of prism elements arranged at the exit surface for redirecting light from the reflective surface by means of total internal reflection and/or refraction
wherein the exit surface, the reflective surface and the light source are arranged such that a major portion of the light outputted through the exit surface without passing the prism elements is outputted towards the secondary surface in a range of directions defining an angle interval relative to a normal to the secondary surface, said angle interval being within the range of 45 degrees to 90 degrees, and
wherein the prism elements, the exit surface, the reflective surface and the light source are arranged such that a major portion of the light redirected by the prism elements is outputted towards the secondary surface in a range of directions defining an angle interval relative to a normal to the secondary surface, said angle interval being within the range of 0 degrees to 80 degrees.

2. (canceled)

3. (canceled)

4. (canceled)

5. The lighting device as defined in claim 1, further comprising means for collimating light from the light source before reflection by the reflective surface.

6. The lighting device as defined in claim 5, wherein the full width half maximum of the degree of collimation of the collimated light before it is reflected by the reflective surface is comprised within the interval of 60 degrees to 30 degrees.

7. The lighting device as defined in claim 1, wherein the optical structure comprises a solid light transmissive body.

8. The lighting device as defined in claim 7, wherein the body has a refractive index being configured such that light from the light source is refracted into a more narrow beam when entering the body so as to provide means for collimating light.

9. The lighting device as defined in claim 1, wherein the reflective surface curved so as to collimate light from the light source.

10. The lighting device as defined in claim 8, wherein the full width half maximum of the degree of collimation of the light collimated by the reflective surface is less than 15 degrees.

11. The lighting device as defined in claim 1, wherein the reflective surface of the optical structure is adapted to redirect light from the light source by means of total internal reflection.

12. The lighting device as defined in claim 1, wherein the exit surface extends in a plane transverse to the average direction of the light reflected by the reflective surface.
